(19) United States
(12) Patent Application Publication
(10) Pub. No.: US 2024/0217130 A1
(43) Pub. Date: Jul. 4, 2024

(54) ELECTRIC HAIR CUTTER HAVING ROTATION SPEED REAL-TIME DETECTION STRUCTURE

(71) Applicant: NINGBO ICLIPPER ELECTRIC APPLIANCE CO., LTD., Ningbo (CN)

(72) Inventor: Haoze WU, Ningbo (CN)

(21) Appl. No.: 18/241,968

(22) Filed: Sep. 4, 2023

(30) Foreign Application Priority Data
Jan. 4, 2023 (CN) 2023200093091

(51) Int. Cl. B26B 19/38; B26B 19/28

(52) U.S. Cl. CPC B26B 19/388; B26B 19/28; H02K 11/215

(57) ABSTRACT

An electric hair cutter having a rotation speed real-time detection structure includes a main body and a cutter head assembly arranged at the front end of the main body; a driving motor, a speed detection assembly, a power supply device and a circuit board are arranged in the main body; an output shaft of the driving motor penetrates through the front end and the rear end of the driving motor, and the front end of the output shaft of the driving motor is connected to the cutter head assembly; the speed detection assembly comprises a magnetic ring and a Hall element, the magnetic ring is fixedly connected to a rear end of the output shaft of the driving motor, and the Hall element is fixedly arranged in the main body and directly faces the magnetic ring.

### TECHNICAL FIELD

This invention generally relates to the technical field of electric hair cutters, and more particularly, to an electric hair cutter having a rotation speed real-time detection structure.

### BACKGROUND

An electric hair cutter is an electric tool for cutting hair. A conventional electric hair cutter comprises a main body and a cutter head assembly arranged at the front end of the main body. The cutter head assembly comprises a fixed cutter holder, a movable cutter holder, a fixed blade, a movable blade and a torsion spring. A driving motor is arranged in the main body, and the driving motor propels the movable blade to reciprocate relative to the fixed blade through an eccentric mechanism such that the hair is smoothly cut.

The rotation speed of the motor may affect the efficiency and comfort of the haircut: with excessively high rotation speed, the temperature of the cutter head reaches an excessively high level and the hair cutter becomes extremely noisy: with excessively low rotation speed, the cutting force of the device becomes insufficient causing hair entanglement during the cutting process. To solve the aforesaid problem, Chinese patent CN216913925U discloses a Hall-effect-based motor speed control mechanism and an electric hair cutter, wherein a speed detection assembly is arranged at a tail end of a motor, and four groups of magnets arranged on a turntable interact with a Hall element to achieve the detection of the rotation speed of the motor. However, because the included angle between the center of the turntable and an adjacent magnet is 90 degrees, an area where the sensing signals cannot be detected exists between the adjacent magnets. Therefore, the signals detected by the speed detection assembly can be inaccurate. Meanwhile, the assembly of the magnets and the turntable often experience mechanical issues. Thus, it is urgent for those skilled in the art to provide a novel electric hair cutter.

### SUMMARY

The purpose of the present invention is to provide an electric hair cutter having a rotation speed real-time detection structure. According to the present invention, the four magnets arranged in a ring shape are replaced by an integral magnetic ring, so that the problem relating to the existence of areas where the sensing signals cannot be detected between adjacent magnets is solved. The magnetic ring is capable of interacting with the Hall element to detect the rotation speed of the output shaft of the driving motor in real time.

To achieve the above purpose, the present invention adopts the following technical solution: an electric hair cutter having a rotation speed real-time detection structure of the present invention comprises a main body and a cutter head assembly arranged at the front end of the main body, wherein a driving motor, a speed detection assembly, a power supply device and a circuit board are arranged in the main body, wherein an output shaft of the driving motor penetrates through the front end and the rear end of the driving motor, and the front end of the output shaft of the driving motor is connected to the cutter head assembly, wherein the speed detection assembly comprises a magnetic ring and a Hall element, wherein the magnetic ring is fixedly connected to a rear end of the output shaft of the driving motor, and the Hall element is fixedly arranged in the main body and directly faces the magnetic ring, wherein the Hall element interacts with the magnetic ring in a magnetic induction manner for detecting the rotation speed of the output shaft of the driving motor in real time, wherein the circuit board is fixedly arranged in the main body and respectively electrically connected to the driving motor and the Hall element.

In another embodiment of the present invention, the circuit board is fixedly arranged at a rear end of the main body corresponding to the driving motor, and the Hall element is fixedly arranged on the circuit board and directly faces the magnetic ring.

In another embodiment of the present invention, an insertion hole is formed in the middle of the magnetic ring, and the magnetic ring is mounted at a rear end of the output shaft of the driving motor in an interference manner through the insertion hole.

In another embodiment of the present invention, a power supply device is arranged in the main body, the power supply device is arranged at an upper end of the circuit board, and two positioning plates for positioning the power supply device are arranged on the circuit board. The power supply device is respectively electrically connected to the driving motor and the circuit board.

Compared with the prior art, the present invention has the following advantages: according to the electric hair cutter of the present invention, the four magnets arranged in a ring shape are replaced by an integral magnetic ring, so that the problem relating to the existence of areas where the sensing signals cannot be detected between adjacent magnets is solved: the magnetic ring is capable of interacting with the Hall element to detect the rotation speed of the output shaft of the driving motor in real time; moreover, the magnetic ring is directly connected to the rear end of the output shaft of the driving motor, so that a process of assembling the magnets on a turntable one by one in the prior art is avoided: in this way, the assembly efficiency is greatly improved, and the structure of the speed detection assembly is simplified; thus, the speed detection assembly achieves a higher integration level and a smaller occupied space.

### BRIEF DESCRIPTION OF THE DRAWINGS

FIG. 1 is a conceptual diagram illustrating an overall structure of the present invention;

FIG. 2 is a conceptual diagram illustrating an internal structure of the present invention;

In Figures: 1—Main Body, 11—Driving Motor, 111—Output Shaft, 12—Speed Detection Assembly, 121—Magnetic Ring, 122—Hall Element, 13—Power Supply Device, 14—Circuit Board, 141—Positioning Plate, 2—Cutter Head Assembly.

### DETAILED DESCRIPTION

Drawings are combined hereinafter to further elaborate the technical solution of the present invention.

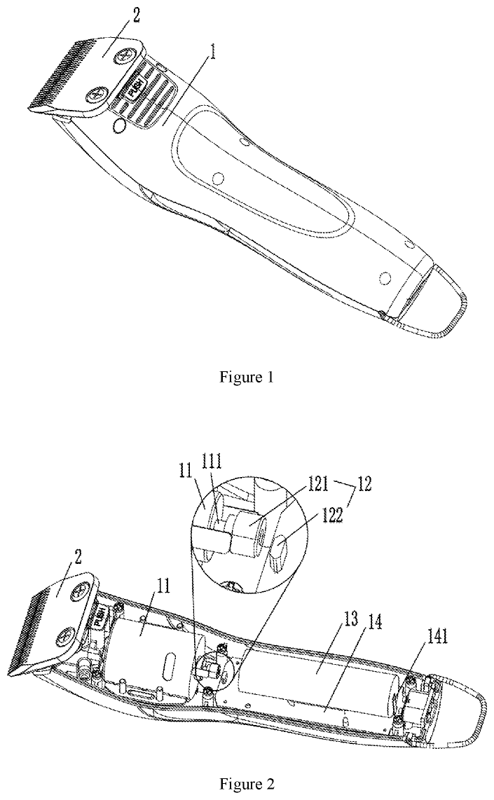

As shown in FIGS. 1-2, the electric hair cutter having a rotation speed real-time detection structure of the present invention comprises a main body and a cutter head assembly arranged at the front end of the main body. The aforesaid forms a basic structure of the present invention.

A driving motor 11, a speed detection assembly 12, a power supply device 13 and a circuit board 14 are arranged in the main body 1. An output shaft 111 of the driving motor 11 penetrates through the front end and the rear end of the driving motor 11, and the front end of the output shaft 111 of the driving motor 11 is connected to the cutter head assembly 2. More specifically, the driving motor propels a movable blade to transversely reciprocate relative to a fixed blade through an eccentric mechanism such that the hair is smoothly cut.

The speed detection assembly 12 comprises a magnetic ring 121 and a Hall element 122, wherein the magnetic ring 121 is fixedly connected to the rear end of the output shaft 111 of the driving motor 11, and the Hall element 122 is fixedly arranged in the main body 1 and directly faces the magnetic ring 121. It should be understood that, the direct-facing-arrangement refers to an arrangement in the left-right direction, and there may be a height difference in the up-down direction. The Hall element 122 interacts with the magnetic ring 121 in a magnetic induction manner for detecting the rotation speed of the output shaft 111 of the driving motor 11 in real time, and the circuit board 14 is fixedly arranged in the main body 1 and respectively electrically connected to the driving motor 11 and the Hall element 122. More specifically, after the speed detection assembly 12 sends a detection result to the circuit board 14, the circuit board 14 determines whether the rotation speed of the driving motor 11 is high or low according to the detection result. Subsequently, the circuit board 14 reduces the voltage of the driving motor 11 or increases the voltage of the driving motor 11 according to the detection result, thereby decelerating or accelerating the driving motor 11 such that the driving motor 11 is kept operating at a stable rotation speed. After the rotation speed of the driving motor 11 is detected, the cutting speed of the cutter head assembly 2 of the electric hair cutter is accurately controlled according to the detected data. When using the electric hair cutter to cut hair, the torsion of the driving motor 11 dynamically varies along the variation of loads, so that the stability of the rotation speed of the driving motor 11 is ensured. In addition, the rotation speeds at different gear positions are accurately controlled.

The circuit board 14 is fixedly arranged at a rear end of the main body 1 corresponding to the driving motor 11, and the Hall element 122 is fixedly arranged on the circuit board 14 and directly faces the magnetic ring 121. More specifically, the Hall element 122 is directly inserted into the circuit board 14 through pins and is electrically connected to the circuit board 14 through pins, which significantly simplifies the assembly structure and the electrical connection structure of the Hall element 122.

An insertion hole is formed in the middle of the magnetic ring 121, and the magnetic ring 121 is mounted at a rear end of the output shaft 111 of the driving motor 11 in an interference manner through the insertion hole. The magnetic ring 121 is directly connected to the rear end of the output shaft 111 of the driving motor 11, so that a process of assembling the magnets on a turntable one by one in the prior art is avoided. In this way, the assembly efficiency is greatly improved, and the structure of the speed detection assembly 12 is simplified. Thus, the speed detection assembly 12 achieves a higher integration level and a smaller occupied space.

A power supply device 13 is arranged in the main body 1, the power supply device 13 is arranged at an upper end of the circuit board 14, and two positioning plates 141 for positioning the power supply device 13 are arranged on the circuit board 14. One positioning plate 141 is attached to the front end surface of the power supply device 13, and the other positioning plate 141 is attached to the rear end surface of the power supply device 13. The power supply device 13 is respectively electrically connected to the driving motor 11 and the circuit board 14. The tail portion of the main body 1 is provided with a charging port, and the charging port is used to charge the power supply device 13 through an electrical connection line.

According to the electric hair cutter of the present invention, the four magnets arranged in a ring shape are replaced by an integral magnetic ring 121, so that the problem relating to the existence of areas where the sensing signals cannot be detected between adjacent magnets is solved. The magnetic ring 121 is capable of interacting with the Hall element 122 to detect the rotation speed of the output shaft 111 of the driving motor 11 in real time.

The above is merely a preferred embodiment of the present invention, and therefore, the equivalent changes or modifications made according to the construction, features and principles described in the present invention shall fall into the scope defined by the claims of the present invention.

1. An electric hair cutter having a rotation speed real-time detection structure, comprising:
a main body, and
a cutter head assembly arranged at a front end of the main body,
wherein a driving motor (11), a speed detection assembly (12), a power supply device (13) and a circuit board (14) are arranged in the main body (1), wherein an output shaft (111) of the driving motor (11) penetrates through a front end and a rear end of the driving motor (11), wherein a front end of the output shaft (111) of the driving motor (11) is connected to the cutter head assembly (2), wherein the speed detection assembly (12) further comprises a magnetic ring (121) and a Hall element (122), wherein the magnetic ring (121) is fixedly connected to a rear end of the output shaft (111) of the driving motor (11), and the Hall element (122) is fixedly arranged in the main body (1) and directly faces the magnetic ring (121), wherein the Hall element (122) interacts with the magnetic ring (121) in a magnetic induction manner for detecting the rotation speed of the output shaft (111) of the driving motor (11) in real time, wherein the circuit board (14) is fixedly arranged in the main body (1) and electrically connected to the driving motor (11) and the Hall element (122).

2. The electric hair cutter having a rotation speed real-time detection structure of claim 1, wherein the circuit board (14) is fixedly arranged at a rear end of the main body (1) corresponding to the driving motor (11), and the Hall element (122) is fixedly arranged on the circuit board (14) and directly faces the magnetic ring (121).

3. The electric hair cutter having a rotation speed real-time detection structure of claim 1, wherein an insertion hole is formed in the middle of the magnetic ring (121), and the magnetic ring (121) is mounted at a rear end of the output shaft (111) of the driving motor (11) in an interference manner through the insertion hole.

4. The electric hair cutter having a rotation speed real-time detection structure of claim 1, wherein a power supply device (13) is arranged in the main body (1), and the power supply device (13) is arranged at an upper end of the circuit board (14), wherein two positioning plates (141) for positioning the power supply device (13) are arranged on the circuit board (14), wherein the power supply device (13) is electrically connected to the driving motor (11) and the circuit board (14).

5. The electric hair cutter having a rotation speed real-time detection structure of claim 2, wherein a power supply device (13) is arranged in the main body (1), and the power supply device (13) is arranged at an upper end of the circuit board (14), wherein two positioning plates (141) for positioning the power supply device (13) are arranged on the circuit board (14), wherein the power supply device (13) is electrically connected to the driving motor (11) and the circuit board (14).

6. The electric hair cutter having a rotation speed real-time detection structure of claim 3, wherein a power supply device (13) is arranged in the main body (1), and the power supply device (13) is arranged at an upper end of the circuit board (14), wherein two positioning plates (141) for positioning the power supply device (13) are arranged on the circuit board (14), wherein the power supply device (13) is electrically connected to the driving motor (11) and the circuit board (14).
